(19) United States
(12) Patent Application Publication
(10) Pub. No.: US 2018/0136647 A1
(43) Pub. Date: May 17, 2018

(54) SEQUENCED DRONE LAUNCH AND RECOVERY

(71) Applicant: Tobias Gurdan, Germering (DE)

(72) Inventor: Tobias Gurdan, Germering (DE)

(21) Appl. No.: 15/721,178

(22) Filed: Sep. 29, 2017

Related U.S. Application Data
(60) Provisional application No. 62/421,370, filed on Nov. 13, 2016.

(51) Int. Cl. G05D 1/00; G08G 5/00; B64C 39/02

(52) U.S. Cl. CPC G05D 1/0027; G08G 5/0069; G08G 5/0065; B64C 2201/126; G08G 5/0013; B64C 2201/143; B64C 39/024

(57) ABSTRACT

Disclosed are methods and systems for launching and recovering drones. The systems and methods may include: receiving, at a computing device comprising a processor, location data for each of a plurality of drones in a plurality of drones; receiving, at the computing device, frame data; and determining, by the computing device, a launch sequence for each of the plurality of drones using the location data and the frame data. The location data may define a launch point for each of the plurality of drones. The frame data may define a location for each of the plurality of drones to form an aerial image.

### CROSS-REFERENCE TO RELATED APPLICATIONS

This application is related to and claims priority to U.S. Provisional Application No. 62/421,370 filed on Nov. 13, 2016, the content of which is hereby incorporated in its entirety.

### TECHNICAL FIELD

Embodiments described generally herein relate to drones. Some embodiments relate to coordinating a launch of multiple drones.

### BACKGROUND

An unmanned aerial vehicle (UAV), commonly known as a drone, is an aircraft without a human pilot aboard. The size of drones may range from small hobby scale suitable for close range operation proximate a user to large scale systems capable of hauling large payloads over many miles. Drones may be used to provide services, perform military operations, or as a hobby.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example schematic of an aerial display in accordance with some embodiments.

FIG. 2 illustrates an example schematic of an aerial display in accordance with some embodiments.

FIG. 3 illustrates example flightpaths for drones in accordance with some embodiments.

FIG. 4 illustrates an example computing device in accordance with some embodiments.

FIG. 5 illustrates an example method in accordance with some embodiments.

FIG. 6 illustrates an example schematic of a drone in accordance with some embodiments.

FIG. 7 illustrates an example method in accordance with some embodiments.

### DETAILED DESCRIPTION

Drone usage is becoming more and more common as prices for drones decrease and the capabilities of drones increase. For example, as disclosed herein, drones may be programmed to launch, fly a predefined flightpath, illuminate one or more onboard light emitting diodes (LED), and recover to a predetermined location. As disclosed herein, these activities may be accomplished without user intervention. With the increased drone capabilities and decreased costs, drone usage may be implemented in a variety of entertainment, safety, or emergency scenarios.

As disclosed herein, a plurality of drones that may make up an aerial display may be arranged on a surface in a predetermined fashion. For example, the plurality of drones may be arranged in a grid, on the ground or a launch pad, prior to launch. Depending on the number of drones, the grid may be divided into subsections. As disclosed herein, a plurality of drones may be termed a drone fleet, a group of drones, a platoon of drones, a battery of drones, a team of drones, or a swarm of drones.

Based on a drone's location within the grid and the initial frame of the aerial display, the initial launch of the drone may be adjusted relative to other drones used for the aerial display. By adjusting the initial launch of each drone, collision avoidance and operational efficiency may be improved. For example, by adjusting the initial launch, the plurality of drones may be launched to avoid two drones flying within a predefined proximity of each other. In addition, the flightpath from a final image of the aerial display may be optimized to avoid collisions as well as reduce the time to recover the plurality of drones.

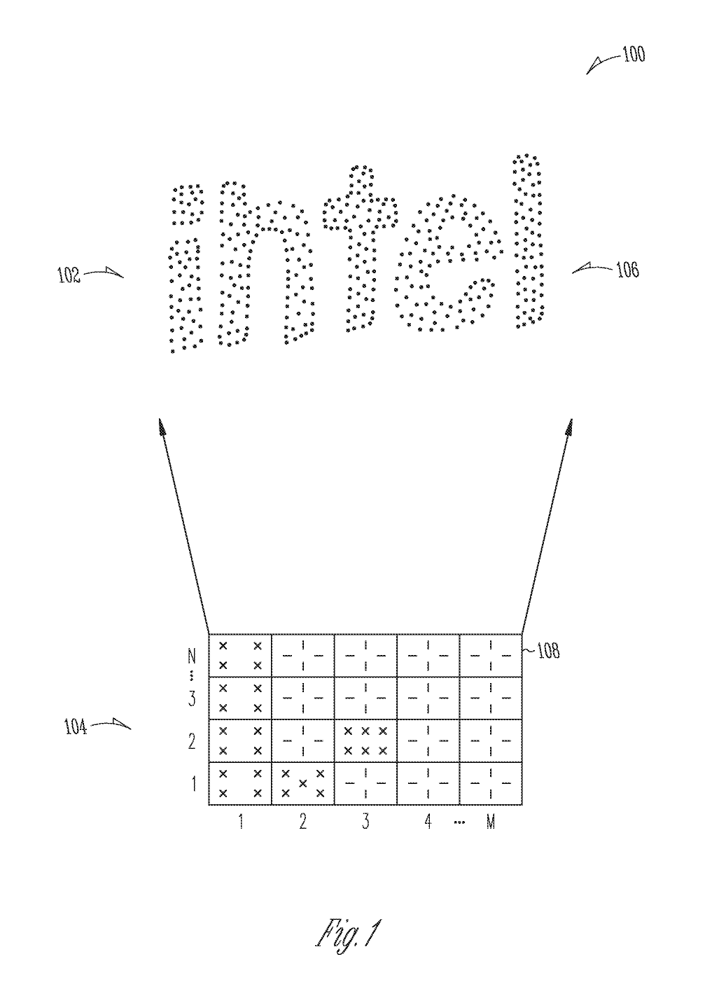

Turning now to the figures, FIG. 1 illustrates an example schematic of an aerial display 100 in accordance with some embodiments. The aerial display 100 may include an initial frame 102 and a launch site 104. The initial frame 102 may be comprised of a plurality of drones 106 (each drone represented by a dot).

Prior to the beginning of a presentation, the plurality of drones 106 may be located at the launch site 104. The plurality of drones 106 may be arranged at the launch site 104 in a variety of fashions. For example, as shown in FIG. 1, the plurality of drones 106 may be arranged in a grid 108. The grid 108 may be subdivided into one or more rows and columns. For instance, as shown in FIG. 1, the grid 108 may include N rows and M columns. Each subsection of the grid 108, defined by the row and column number, may include one or more drones 106 (each drone represented by an X). For example, as shown in FIG. 1, subsection (1, 4) may include four drones 106, subsection (2, 1) may include five drones 106, and subsection (3, 2) may include six drones 106. The number and configuration of the drones 106 in each subsection may also differ. For example, the drones 106 in a first subsection may be arranged in a grid fashion such as a 3×3 or 6×6 fashion. The drones 106 in a second subsection may include six drones arranged in a circular fashion. The location of each drone 106 within the subsection may vary depending on the nature of the aerial performance.

The spacing of the plurality of drones 106 within the grid 108 may vary depending on the type of drone and the aerial performance. For example, larger drones maybe spaced closer to smaller drones. In addition, because of the sequenced launch and recovery disclosed herein, the drones 106 may generally be spaced close together. For example, because of the sequenced launch and recovery, while on the launch site 104, the drones 106 may be spaced from about 2 cm to about 5 cm apart.

While FIG. 1 shows the plurality of drones 106 arranged in the grid 108, the plurality of drones 106 do not have to be arranged in a grid. For example, instead of a structured organization, the plurality of drones 106 may be placed at random within a launch area 104. Because the plurality of drones 106 are able to transmit their locations to the computing device (not shown), there is no requirement that the plurality of drones 106 be placed in grid or other ordered arrangement prior to launch or recovery.

As discussed herein, each of the plurality of drones 106 may be programmed with a flightpath. The flightpath may define the path the drone 106 may fly from the initial launch site 104, though the various frames of a drone-based visual presentation, and to a landing site, which may be the initial launch site 104 or a different location.

The launch site 104 is shown in planar view in FIG. 1, the elevation of the plurality of drones 106 relative to a reference datum (e.g., the ground) may be different prior to launching the plurality of drones 106. For example, a first portion of the plurality of drones 106 may be located on a platform and a second portion of the plurality of drones 106 may be located on the ground. Locating a portion of the plurality of drones 106 at a different elevation than another portion of the plurality of drones 106 may help with collision avoidance during initial launch. For example, a first drone 106 located two feet above a second drone 106 may be launched shortly before the second drone 106. Stated another way, the vertical spacing of the drones 106 may minimize the delay between launching the first drone 106 and the second drone 106.

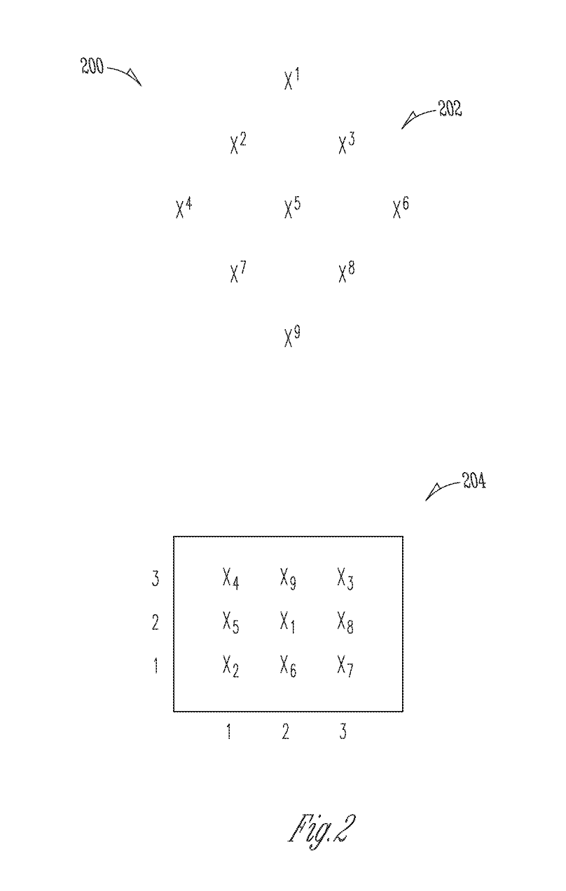

FIG. 2 illustrates an example schematic of an aerial display 200 in accordance with some embodiments. As shown in FIG. 2, the aerial display 200 may include an initial frame 202 and a launch site 204. For simplicity, the initial frame 202 is comprised of nine drones, labeled 1-9.

Prior to forming the initial frame 202, the drones 1-9 may be set up at the launch site 204. As shown in FIG. 2, the drones 1-9 may be arranged in a grid like manner. Once the drones 1-9 are located at the launch site 204, their location may be determined and entered into a computer as described herein. Once their initial location is determined, the drones 1-9 may be assigned a location (or pixel) within the initial frame 202. For example, drone 5, located at the (1,2) position on the launch site 204, may be assigned the center position in the shape forming the initial frame 202. The center position can be defined as a coordinate or ordered triple (X,Y,Z), where X is a latitude, Y is a longitude, and Z is an altitude. In addition, the ordered triple can be a distance from a reference point, or origin. For example, X may be X feet in the positive x-axis, Y may be Y feet in the positive y-axis, and Z may be Z feet in the positive z-axis, where the coordinate system is aligned to an agreed upon system. For instance, the x-axis may be the east-west attitude line, the y-axis may be the north-south longitude line, and the z-axis may be the orthogonal axis extending from the x-y plane.

The assignment of each drone 1-9 to a position within the initial frame 202 may be dependent on the location of the drone within the launch site 205 and its position in the initial frame 202. For example, the drones 1-9 may be assigned a position based on a distance from their initial location within the launch site 204. For instance, the drones 1-9 may be assigned positions within the initial frame 202 that minimizes a flight distance from the launch site 204 to a location within the initial frame 202. The minimization of the flight distance may be global minimum where the overall flight distance of the drones 1-9 (the total distance flown by the drones 1-9) is minimized or minimizing the flight distance of each drone individually.

In addition, the drones 1-9 may be assigned positions within the initial frame 202 that minimize a flight time from initial launch to completion of the initial frame 202. For example, as disclosed herein, the drones 1-9, may launch at different times and may fly different distances and at different velocities. As a result, a drone that has to fly the furthest distance may launch before a drone that flies the shortest distance. Having a staggered launch time may allow the drone that flies the furthest distance to arrive at its location at approximately the same time as the drone that flies the shortest distance arrives at its location. In addition, having different velocities may allow drones to launch at the same time, fly at different velocities, and arrive at locations to form the initial frame 202 at approximately the same time.

Furthermore, the staggered launch sequence may help with collision avoidance. For example, the precision or accuracy of a global positioning system (GPS) receiver within each of the drones 1-9 may only be able to determine a location of a respective drone to within +/−10 cm, 1 m, etc. As a result, two drones located within 20 cm, 2 m, etc. (10 cm, 1 m, etc. for each drone) of each other could collide. By staggering the launch of the drones 1-9, a distance between the drones 1-9 may be maintained to aid in collision avoidance.

During the launch of the drones 1-9, the drones 1-9 may or may not take the most direct route to a location within the initial frame 202. For example, instead of flying in a straight line to a location within the initial frame 202, the drones 1-9 may first fly straight up a preset distance. By flying straight up, the drones 1-9 may first elevate above an obstacle, such as a structure or spectators. In addition, flying upwards first may allow for vertical separation between the drones 1-9 to avoid a collision during launch. For example, if two drones are located within a certain distance of one another on the launch site 204, then one of the drones may launch first such that the second drone does not launch until the first drone is a safe distance (e.g., 1 m) from the second drone.

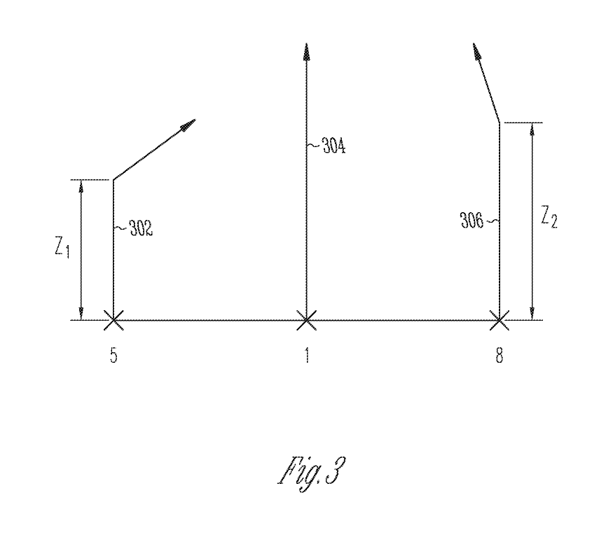

FIG. 3 illustrates example flightpaths for drones 1, 5, and 8 in accordance with some embodiments. As shown in FIG. 3, drones 5, 1, and 8 may have different flightpaths 302, 304, and 306, respectively. The location of drone 1 in the initial frame 202 may be a vertex of two segments formed by various drones as shown in FIG. 2. Given the location of drone 1 in the initial frame 202, drone 1 may have the greatest distance to travel. As a result, drone 1 may launch first. In addition, drone 5 may have a location in the initial frame 202 that is proximate drone 1, but with a lower altitude. As a result, if drone 1 and drone 5 launched at the same time, it is possible that flightpaths 302 and 304 may be too close to one another and that drone 1 and drone 5 may collide.

Furthermore, if drone 5 were to fly the most direct path to its location in the initial frame 202, drone 1 and drone 5 may collide if launched at the same time. As a result, the flightpath 302 may include a vertical segment having a distance Z₁. After completing the vertical segment, the flightpath 302 may be a direct route to drone 5's location in the initial frame 202. Flightpath 306 may also include a vertical segment having a distance Z₂. Z₁ and Z₂ may or may not be the same height. For example, Z₁ may be 1 meter and Z₂ may be 2 meters. Alternatively, the vertical segments may be of the same height such that Z₁ may be 10 meters and Z₂ may be 10 meters. Once reaching the designated height above ground level (AGL) or other reference datum, the drones 5 and 8 may proceed to fly to their respective locations in the initial frame 202.

The determination of flightpaths, launch timings, launch sequence, etc. may be determined by a computing device and transmitted to each of the drones as disclosed herein.

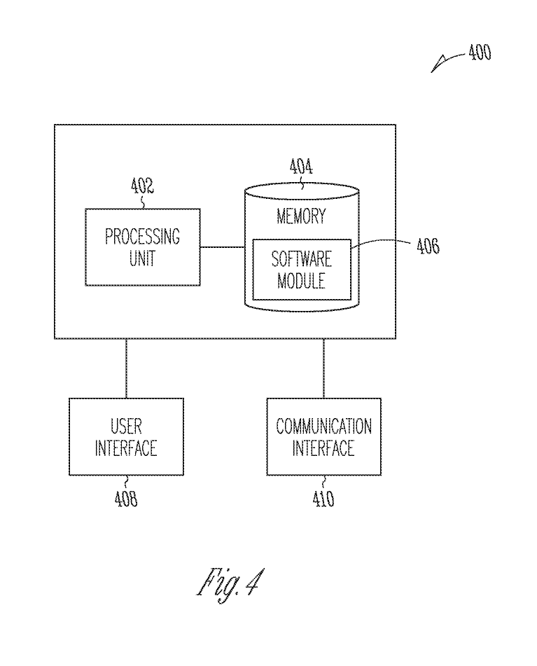

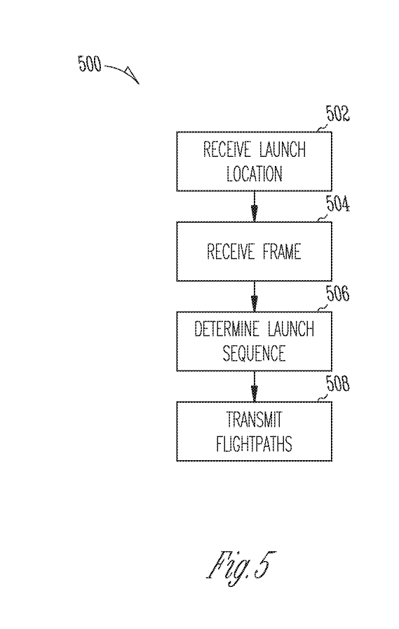

FIG. 4 shows an example schematic of a computing device 400 in accordance with some embodiments. The computing device 400 may be implemented as part of the computing network or as a standalone system. As shown in FIG. 4, the computing device 400 may include a processing unit 402 and a memory unit 404. The memory unit 404 may include a software module 406. While executing on the processing unit 402, the software module 406 may perform processes for commanding a drone, including, for example, one or more stages included in method 500 described below with respect to FIG. 5.

The computing device 400 may include a user interface 408. The user interface 408 may include any number of devices that allow a user to interface with the computing device 400. Non-limiting examples of the user interface 408 include a keypad, joystick, a display (touchscreen or otherwise), etc.

The computing device 400 may include a communications interface 410. The communications interface 410 may allow the computing device 400 to communicate with the drones 1-9 or other computing devices. Non-limiting examples of the communications interface 410 include, automatic dependent surveillance-broadcast (ADS-B) In/Out modules, cellular modules, Ethernet cards (wireless or wired), Bluetooth® transmitters and receivers, near-field communications modules, etc.

The computing device 400 may be implemented using a personal computer, a network computer, a mainframe, a handheld device, a personal digital assistant, a smartphone, or any other similar microcomputer-based workstation. The computing device 400 may be located in close proximity to the launch site 104 or 204. The computing device 400 may also be remote from the launch site 104 or 204. For instance, the computing device 400 may be located in a control room that is not in close proximity to the launch site 104 and 204. The computing device 400 may utilize the communications interface 410, such as a transmitter located proximate the launch site 104 or 204, to transmit signals and data to the plurality of drones.

As used herein, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof; and the like. Thus, the term application may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers).

The term “machine-readable medium” may include any medium that is capable of storing, encoding, or carrying instructions for execution by a machine (e.g., the processing unit 402 or any other module) and that cause a machine to perform any one or more of the techniques of the present disclosure, or that is capable of storing, encoding or carrying data structures used by or associated with such instructions. In other words, the memory unit 404 may include instructions and may therefore be termed a machine-readable medium in the context of various embodiments. Other non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium utilizing any one of a number of transfer protocols (e.g., frame relay, internet protocol (IP), TCP, user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1×* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

The term “transmission medium” shall be taken to include any intangible medium that is capable of storing, encoding or carrying instructions for execution by hardware processing circuitry, and includes digital or analog communications signals or other intangible medium to facilitate communication of such software.

FIG. 5 illustrates an example method 500 in accordance with some embodiments disclosed herein. The method 500 may begin at stage 502 where a launch location for each of the drones (such as drones 1-9) may be received at the computing device. The launch location may be received in multiple ways. For example, each drone may transmit its location to the computing device. For instance, using a GPS receiver attached to a drone, the drone may determine its location and transmit the location to the computing device. In another embodiment, a user may enter the launch location of each drone into the computing device, either manually or by uploading a file, such as a spreadsheet, containing the launch locations.

The computing device may use data from multiple sources to calibrate the launch location. For example, upon receiving the GPS data from each of the drones, the computing device may utilized a known location received from a launch pad that the plurality of drones may rest upon prior to launch. The launch pad may be located at the launch site and received via wireless communication such as Wi-Fi, infrared, near-field-communication (NFC), etc. The computing device may utilize the known location of each of the drones and the GPS data received from each of the plurality of drones to create a calibration table that corrects any error that may be associated with the GPS data. For example, a more precise location of the launch pad may be known. Using GPS data from a GPS receiver located at the launch site and the know coordinates for the launch site, the computing device may calculate a correction factor or other calibration curve used to correct for possible errors associated with the GPS data or other location information received from the drones.

Before an initial launch each of the drones, the correction fact, calibration curve, or calibration table may be used to adjust operating altitudes and vertical separation. For example, one of the drones may have a location of X, Y, Z, where X is a latitude, Y is a longitude, and Z is an altitude. The altitude may be in reference to sea level (MSL) or a reference datum defined by an operator. The drone may report its location as being X+0.3 m, Y−0.2 m, and Z. Using this information, the computing device 400 may adjust any latitude coordinates by 0.3 m and any longitude coordinates by −0.2 m.

From stage 502, the method 500 may proceed to stage 504 where the initial frame may be received at the computing device. For example, the various frames of an aerial show may be received as one or more files that contain coordinates for each point within the aerial show that a drone is needed. The coordinates may be absolute in relation to the Earth, such as geographic latitude and longitude values with a height above sea level. In addition, the coordinates may be relative to a reference point. For instance, each of the coordinates may be relative to a beacon or other point associated with the launch site.

The coordinates may also correspond to pixel locations. For example, each drone may represent a pixel of an aerial image. As a result, the drones may be assigned pixel numbers and each pixel for each frame of the aerial image may have a corresponding coordinate. Thus, the drone can be assigned a pixel number or a coordinate to form the aerial image.

From stage 504, the method 500 may proceed to stage 506 where a launch sequence may be determined. For example, the computing device may utilize the initial launch location data for each drone and the coordinates or pixel data for the initial frame to determine flightpaths for each of the drones. In determining the flightpaths for each of the drones, the computing device may utilize data about each drone such as acceleration rates, deceleration rates, agility, top speeds, etc. to determine a flight time for each drone to reach one or more of the coordinates for the initial frame. In addition, the computing device may use the initial launch location and the coordinates for the initial frame to determine a flight distance for each drone at the launch site to each of the coordinates for the initial frame.

Use the flight times and distances, the computing device may sequence each of the drones for launch. For example, the computing device may sequence each of the drones to launch in a manner that minimizes the total flight time for the plurality of drones. In addition, sequencing each of the drones may include assigning each of the drones to a coordinate of the initial frame. The plurality of drones may be assigned coordinates of the initial frames that may minimize flightpaths that cross, the distance a drone travels to a coordinate, a flight time, etc. For instance, a first drone may fly faster than a second drone. As a result, the first drone may be assigned a coordinate that is a greater distance from its launch site, but results in an approximately equal flight time as the second drone due to the distance in airspeeds.

Furthermore, the computing device may assign velocities to each of the drones. For example, two drones may cover different distances and launch at the same time. Thus, to have to two drones arrive at their respective locations at approximately the same time, one of the drones may fly faster than the other. As such, as part of determining the launch sequence, the computing device may also determine velocities that the various drones need to fly in order to form the frame of the aerial image.

From stage 506, the method 500 may proceed to stage 508, where the computing device may transmit flight profiles to each of the drones. The flight profiles may include the coordinates (i.e., location), speed, lighting configuration, etc. for each drone during the aerial performance. For example, during the sequencing stage, the computing device may have computed flightpaths that minimize collision probabilities, flight distances, velocities, etc. and save the flight information as a launch or recovery schedule. The various flightpaths, launch times, etc. (i.e., the launch or recovery schedule) may be transmitted to each of the drones. Each of the drones may receive a flight profile that is specific to that individual drone, or each of the drones may receive the flight profiles for every drone used in the aerial show. By having each drone aware of the flightpath of each drone, bandwidth and computational efficiency may be achieved. For instance, each drone may have a unique identifier and each flight profile may be associated with one of the unique identifiers. Instead of making a transmission for each drone, which may number into the 100's, 1,000's, 10,000's or even 100,000's, the computing device may make a single transmission received by each drone. The individual drones may utilize their unique identifier to identify their particular flight profile from the plurality of flight profiles.

While the method 500 has been described in terms of launching the plurality of drones, the method 500 may also be used for recovery of the plurality of drones to a recovery point. The recovery point may be the point from which the a drone departed (i.e., its launch point). For example, prior to launching the plurality of drones, the computing device may have information regarding a final frame of the aerial show. Using the information for the final frame and locations of each drone in the final frame, the computing device may determine a landing sequence. The landing sequence may minimize flight times, flight distances, etc. to recover the plurality of drones in an efficient manner. Also, when the plurality of drones are recovered, the plurality of drones do not have to return to their respective launch positions. The plurality of drones may land at a different site or at different positions within the grid or launch pads.

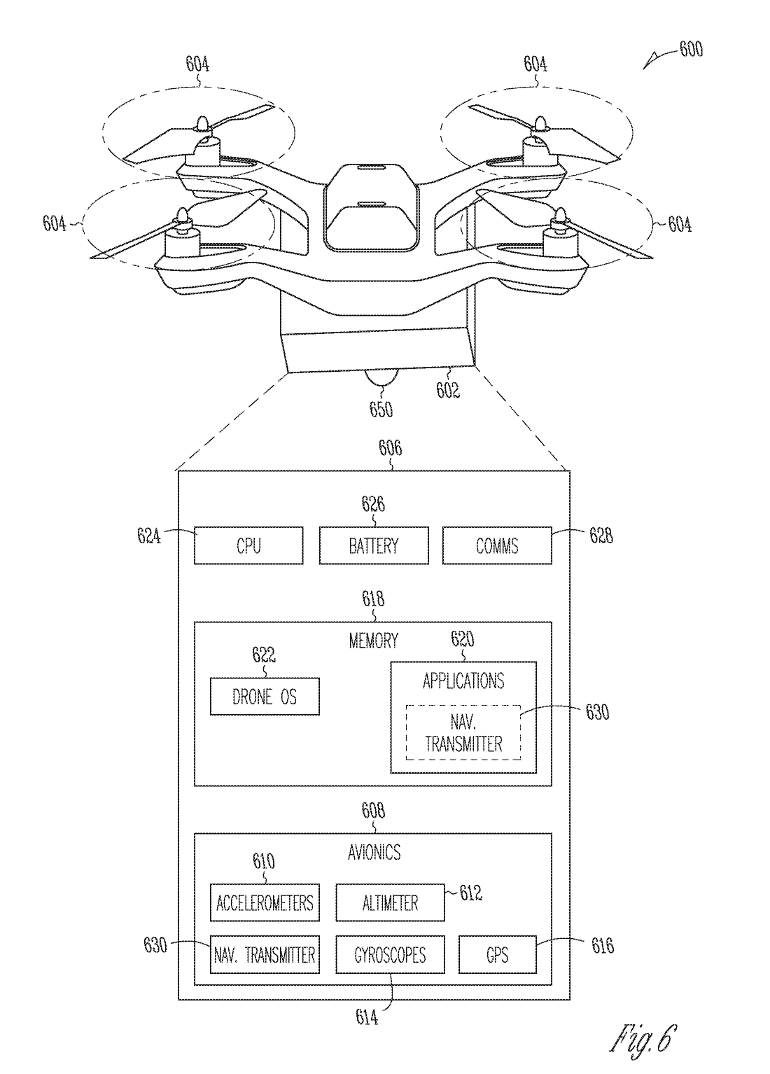

FIG. 6 shows an example schematic of the drone 600, such as one of the drones 1-9 in accordance with some embodiments. As shown in FIG. 6, the drone 600 may include an airframe 602, a flight mechanism 604, and computing environment 606. The airframe 602 may be made of made of polymers, metals, etc. and the other components of the drone 600 may be secured to the airframe 602.

The flight mechanism 604 may include mechanisms that may propel the drone 600 through the air. For example, the flight mechanism 604 may include propellers, rotors, turbofans, turboprops, etc. The flight mechanism 604 may operably interface with avionics 608. The avionics 608 may be part of the computing environment 606 (as shown in FIG. 6) or standalone components. For example, the avionics 608 may include accelerometers 610, an altimeter 612, gyroscopes 614, and a GPS receiver 616.

The various components of the avionics 608 may be standalone components or may be part of an autopilot system or other avionics package. For example, the altimeter 612 and GPS receiver 616 may be part of an autopilot system that includes one or more axes of control. For instance, the autopilot system may be a two-axis autopilot that may maintain a preset course and hold a preset altitude. The avionics 608 may be used to control in-flight orientation of the drone 600. For example, the avionics 608 may be used to control orientation of the drone 600 about pitch, bank, and yaw axes while in flight.

The avionics 608 may allow for autonomous flight. For example, as described herein, the drone 600 may receive a flightpath that the drone 600 may fly without further user input. In addition, the avionics 608 may include a navigation transmitter 630 that may be used to transmit commands to the flight mechanism 604. While FIG. 6 shows the navigation transmitter 630 as part of the avionics 608, the navigation transmitter 630 may be software stored in a memory 618 as shown by dashed navigation transmitter 630.

The computing environment 606 may also include the memory 618 that may store applications 620 and a drone operating system (OS) 622. The applications 620 may include lighting controls for controlling one or more LEDs 650. The applications 620 may include a communications program that may allow drone 600 to communicate with a computing device (e.g., the computing device 400 of FIG. 4). In addition, the applications 620 may include software that functions as the navigation transmitter 630.

The memory 618 may provide a secure area for storage of components used to authenticate communications between the drone 600 and the computing device. For example, the memory 618 may store SSL certificates or other security tokens. The data stored in the memory 618 may be read-only data such that during operation the data cannot be corrupted or otherwise altered by malware, viruses, or by other users that may try and take control of the drone 600.

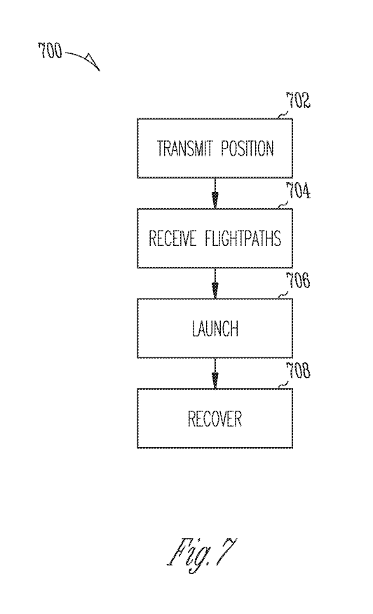

The computing environment 606 may include a central processing unit (CPU) 624, a battery 626, and a communications interface 628. The CPU 624 may be used to execute operations and method steps, such as those described herein with regard to FIGS. 5 and 7. The memory 618 also may store data received by the drone 600 as well as programs and other software utilized by the drone 600. For example, the memory 618 may store instructions that, when executed by the CPU 624, cause the CPU 624 to perform operations such as those described herein.

The communications interface 628 may include transmitters, receivers, or transceivers that may be used to communicate with the computing device. For example, the communications interface 628 may include an automatic dependent surveillance-broadcast (ADS-B) receiver (ADS-B In) or transmitter (ADS-B Out) that may send and receive data. In addition, the communications interface 628 may include a cellular interface or other wireless credential exchange modules. For example, the communications interface 628 may include an ADS-B In-and-Out module that allows the drone 600 to transmits its position to the computing device and also allow the drone 600 to receive the flightpaths and other data from the computing device.

While FIG. 6 shows various components of the drone 600, not all components shown in FIG. 6 are required. For example, drone 600 may not have the gyroscopes 614, the altimeter 614, etc.

FIG. 7 illustrates an example method 700 in accordance with some embodiments. The method 700 may begin at stage 702 where a drone (e.g., drone 600 of FIG. 6) may transmit its position to a computing device (e.g., computing device 400 of FIG. 4). As disclosed herein, the drone may utilize a GPS receiver to determine its location and a transmitter to transmit its location to the computing device.

From stage 702, the method 700 may proceed to stage 704 where the drone may receive a flight profile. As disclosed herein, the drone may receive a flight profile that defines one or more flightpaths for the drone or the drone may receive a flight profile that defines one or more flightpaths for each drone in an aerial show and select an appropriate flight path from the flightpaths. The flightpaths may include a launch sequence or a recovery schedule.

From stage 704, the method 700 may proceed to stage 706, where the drone may launch from the launch pad. As disclosed herein, the drone may launch in a sequence as defined in the flight profile. From stage 706, the method may proceed to stage 708, where the drone may be recovered. As disclosed herein, recovery of the drone 600 may be based on a sequence determined by the computing device. In addition, the drone may utilize a signal, such as an inferred (IR) signal to recover. For example, an array of IR transmitters may be transmitting signals identifiable by the plurality of drones. The plurality of drones may utilize the IR signals as guides to a recovery location.

### EXAMPLES

Example 1 is a method for determining a launch sequence for an aerial show, the method comprising: receiving, at a computing device comprising a processor, location data for each of a plurality of drones, the location data defining a launch point for each of the plurality of drones; receiving, at the computing device, frame data, the frame data defining a location for each of the plurality of drones to form an aerial image; and determining, by the computing device, the launch sequence for each of the plurality of drones using the location data and the frame data.

In Example 2, the subject matter of Example 1 optionally includes wherein the location data is received from each of the plurality of drones.

In Example 3, the subject matter of any one or more of Examples 1-2 optionally include wherein the launch point for each of the plurality of drones is a coordinate.

In Example 4, the subject matter of Example 3 optionally includes wherein the coordinate is a geographic coordinate.

In Example 5, the subject matter of any one or more of Examples 3-4 optionally include wherein the coordinate is relative to a fixed object.

In Example 6, the subject matter of any one or more of Examples 1-5 optionally include wherein determining the launch sequence includes determining an overall shortest flight distance for the plurality of drones.

In Example 7, the subject matter of any one or more of Examples 1-6 optionally include wherein determining the launch sequence includes determining a shortest flight distance for each of the plurality of drones.

In Example 8, the subject matter of any one or more of Examples 1-7 optionally include wherein determining the launch sequence includes determining a flight path for each of the plurality of drones from the launch point to the location within the aerial image for each of the plurality of drones.

In Example 9, the subject matter of Example 8 optionally includes wherein the flight path for a drone of the plurality of drones is a straight line.

In Example 10, the subject matter of any one or more of Examples 8-9 optionally include wherein the flight path for a drone of the plurality of drones includes a vertical segment having a preset length above a launch pad.

In Example 11, the subject matter of any one or more of Examples 1-10 optionally include saving the launch sequence to a memory of the computing device.

In Example 12, the subject matter of any one or more of Examples 1-11 optionally include determining a velocity for each of the plurality of drones.

In Example 13, the subject matter of Example 12 optionally includes wherein determining the velocity for each of the plurality of drones includes minimizing an average velocity for the plurality of drones.

In Example 14, the subject matter of any one or more of Examples 12-13 optionally include wherein determining the velocity for each of the plurality of drones includes minimizing the velocity for each of the plurality of drones.

In Example 15, the subject matter of any one or more of Examples 1-14 optionally include saving a launch time, flight path, and velocity for each of the plurality of drones in a launch schedule.

In Example 16, the subject matter of Example 15 optionally includes transmitting the launch sequence to each of the plurality of drones.

Example 17 is at least one computer-readable medium comprising instructions to perform any of the methods of Examples 1-16.

Example 18 is an apparatus comprising means for performing any of the methods of Examples 1-16.

Example 19 is a system for determining a launch sequence for an aerial show, the system comprising: a processor; and a memory including instructions that, when executed by the processor, cause the processor to: receive location data for each of a plurality of drones, the location data defining a launch point for each of the plurality of drones, receive frame data defining a location for each of the plurality of drones to form an aerial image, and determine the launch sequence for each of the plurality of drones using the location data and the frame data.

In Example 20, the subject matter of Example 19 optionally includes wherein the location data is received from each of the plurality of drones.

In Example 21, the subject matter of any one or more of Examples 19-20 optionally include wherein the launch point for each of the plurality of drones is a coordinate.

In Example 22, the subject matter of Example 21 optionally includes wherein the coordinate is a geographic coordinate.

In Example 23, the subject matter of any one or more of Examples 21-22 optionally include wherein the coordinate is relative to a fixed object.

In Example 24, the subject matter of any one or more of Examples 19-23 optionally include wherein determining the launch sequence includes instructions that, when executed by the processor, cause the processor to determine an overall shortest flight distance for the plurality of drones.

In Example 25, the subject matter of any one or more of Examples 19-24 optionally include wherein determining the launch sequence includes instructions that, when executed by the processor, cause the processor to determine a shortest flight distance for each of the plurality of drones.

In Example 26, the subject matter of any one or more of Examples 19-25 optionally include wherein determining the launch sequence includes instructions that, when executed by the processor, cause the processor to determine a flight path for each of the plurality of drones from the launch point to the location within the aerial image for each of the plurality of drones.

In Example 27, the subject matter of Example 26 optionally includes wherein the flight path for a drone of the plurality of drones is a straight line.

In Example 28, the subject matter of any one or more of Examples 26-27 optionally include wherein the flight path for a drone of the plurality of drones includes a vertical segment having a preset length above the launch pad.

In Example 29, the subject matter of any one or more of Examples 19-28 optionally include instructions that, when executed by the processor, cause the processor to save the launch sequence to the memory.

In Example 30, the subject matter of any one or more of Examples 19-29 optionally include instructions that; when executed by the processor, cause the processor to determine a velocity for each of the plurality of drones.

In Example 31, the subject matter of Example 30 optionally includes wherein determining the velocity for each of the plurality of drones includes instructions that, when executed by the processor, cause the processor to minimize an average velocity for the plurality of drones.

In Example 32, the subject matter of any one or more of Examples 30-31 optionally include wherein determining the velocity for each of the plurality of drones includes instructions that, when executed by the processor, cause the processor to minimize the velocity for each of the plurality of drones.

In Example 33, the subject matter of any one or more of Examples 19-32 optionally include instructions that, when executed by the processor, cause the processor to save a launch time, flight path, and velocity for each of the plurality of drones in a launch schedule.

In Example 34, the subject matter of Example 33 optionally includes instructions that, when executed by the processor, cause the processor to transmit the launch sequence to each of the plurality of drones.

Example 35 is a system for determining a launch sequence for an aerial show, the system comprising: means for receiving location data for each of a plurality of drones, the location data defining a launch point for each of the plurality of drones; means for receiving frame data, the frame data defining a location for each of the plurality of drones to form an aerial image; and means determining the launch sequence for each of the plurality of drones using the location data and the frame data.

In Example 36, the subject matter of Example 35 optionally includes wherein the location data is received from each of the plurality of drones.

In Example 37, the subject matter of any one or more of Examples 35-36 optionally include wherein the launch point for each of the plurality of drones is a coordinate.

In Example 38, the subject matter of Example 37 optionally includes wherein the coordinate is a geographic coordinate.

In Example 39, the subject matter of any one or more of Examples 37-38 optionally include wherein the coordinate is relative to a fixed object.

In Example 40, the subject matter of any one or more of Examples 35-39 optionally include wherein the means for determining the launch sequence includes means for determining an overall shortest flight distance for the plurality of drones.

In Example 41, the subject matter of any one or more of Examples 35-40 optionally include wherein the means for determining the launch sequence includes means for determining a shortest flight distance for each of the plurality of drones.

In Example 42, the subject matter of any one or more of Examples 35-41 optionally include wherein the means for determining the launch sequence includes means for determining a flight path for each of the plurality of drones from the launch point to the location within the aerial image for each of the plurality of drones.

In Example 43, the subject matter of Example 42 optionally includes wherein the flight path for a drone of the plurality of drones is a straight line.

In Example 44, the subject matter of any one or more of Examples 42-43 optionally include wherein the flight path for a drone of the plurality of drones includes a vertical segment having a preset distance above a launch pad.

In Example 45, the subject matter of any one or more of Examples 35-44 optionally include means for saving the launch sequence to a memory of a computing device.

In Example 46, the subject matter of any one or more of Examples 35-45 optionally include means for determining a velocity for each of the plurality of drones.

In Example 47, the subject matter of Example 46 optionally includes wherein the means for determining the velocity for each of the plurality of drones includes means for minimizing an average velocity for the plurality of drones.

In Example 48, the subject matter of any one or more of Examples 46-47 optionally include wherein the means for determining the velocity for each of the plurality of drones includes means for minimizing the velocity for each of the plurality of drones.

In Example 49, the subject matter of any one or more of Examples 35-48 optionally include means for saving a launch time, flight path, and velocity for each of the plurality of drones in a launch schedule.

In Example 50, the subject matter of Example 49 optionally includes means for transmitting the launch sequence to each of the plurality of drones.

Example 51 is at least one computer readable medium including instructions that, when executed by a processor, cause the processor to: receive location data for each of a plurality of drones, the location data defining a launch point for each of the plurality of drones; receive frame data, the frame data defining a location for each of the plurality of drones to form an aerial image; and determine the launch sequence for each of the plurality of drones using the location data and the frame data.

In Example 52, the subject matter of Example 51 optionally includes wherein the location data is received from each of the plurality of drones.

In Example 53, the subject matter of any one or more of Examples 51-52 optionally include wherein the launch point for each of the plurality of drones is a coordinate.

In Example 54, the subject matter of Example 53 optionally includes wherein the coordinate is a geographic coordinate.

In Example 55, the subject matter of any one or more of Examples 53-54 optionally include wherein the coordinate is relative to a fixed object.

In Example 56, the subject matter of any one or more of Examples 51-55 optionally include wherein determining the launch sequence includes instructions that, when executed by the processor, cause the processor to determine an overall shortest flight distance for the plurality of drones.

In Example 57, the subject matter of any one or more of Examples 51-56 optionally include wherein determining the launch sequence includes instructions that, when executed by the processor, cause the processor to determine a shortest flight distance for each of the plurality of drones.

In Example 58, the subject matter of any one or more of Examples 51-57 optionally include wherein determining the launch sequence includes instructions that, when executed by the processor, cause the processor to determine a flight path for each of the plurality of drones from the launch point to the location within the aerial image for each of the plurality of drones.

In Example 59, the subject matter of Example 58 optionally includes wherein the flight path for a drone of the plurality of drones is a straight line.

In Example 60, the subject matter of any one or more of Examples 58-59 optionally include wherein the flight path for a drone of the plurality of drones a preset length above a launch pad.

In Example 61, the subject matter of any one or more of Examples 51-60 optionally include instructions that, when executed by the processor, cause the processor to save the launch sequence to a memory of a computing device.

In Example 62, the subject matter of any one or more of Examples 51-61 optionally include instructions that, when executed by the processor, cause the processor to determine a velocity for each of the plurality of drones.

In Example 63, the subject matter of Example 62 optionally includes wherein determining the velocity for each of the plurality of drones includes instructions that, when executed by the processor, cause the processor to minimize an average velocity for the plurality of drones.

In Example 64, the subject matter of any one or more of Examples 62-63 optionally include wherein determining the velocity for each of the plurality of drones includes instructions that, when executed by the processor, cause the processor to minimize the velocity for each of the plurality of drones.

In Example 65, the subject matter of any one or more of Examples 51-64 optionally include instructions that, when executed by the processor, cause the processor to save a launch time, flight path, and velocity for each of the plurality of drones in a launch schedule.

In Example 66, the subject matter of Example 65 optionally includes instructions that, when executed by the processor, cause the processor to transmit the launch sequence to each of the plurality of drones.

Example 67 is a method for determining a recovery sequence, the method comprising: receiving, at a computing device comprising a processor, frame data, the frame data defining a location for each of a plurality of drones forming an aerial image; receiving, at the computing device, recovery data for each of the plurality of drones, the recovery data defining a recovery point for each of the plurality of drones; and determining, by the computing device, the recovery sequence for each of the plurality of drones using the recovery data and the frame data.

In Example 68, the subject matter of Example 67 optionally includes wherein the recovery data is received from each of the plurality of drones prior to a launch.

In Example 69, the subject matter of any one or more of Examples 67-68 optionally include wherein the recovery point for each of the plurality of drones is a coordinate.

In Example 70, the subject matter of Example 69 optionally includes wherein the coordinate is a geographic coordinate.

In Example 71, the subject matter of any one or more of Examples 69-70 optionally include wherein the coordinate is relative to a fixed object.

In Example 72, the subject matter of any one or more of Examples 67-71 optionally include wherein determining the recovery sequence includes determining an overall shortest flight distance for the plurality of drones.

In Example 73, the subject matter of any one or more of Examples 68-72 optionally include wherein determining the recovery sequence includes determining a shortest flight distance for each of the plurality of drones.

In Example 74, the subject matter of any one or more of Examples 68-73 optionally include wherein determining the recovery sequence includes determining a flight path for each of the plurality of drones from the location forming the aerial image to the recovery point.

In Example 75, the subject matter of Example 74 optionally includes wherein the flight path for a drone of the plurality of drones is a straight line.

In Example 76, the subject matter of any one or more of Examples 74-75 optionally include wherein the flight path for a drone of the plurality of drones a vertical segment having a present length above a launch pad.

In Example 77, the subject matter of any one or more of Examples 67-76 optionally include saving the recovery sequence to a memory of the computing device.

In Example 78, the subject matter of any one or more of Examples 67-77 optionally include determining a velocity for each of the plurality of drones.

In Example 79, the subject matter of Example 78 optionally includes wherein determining the velocity for each of the plurality of drones includes minimizing an average velocity for the plurality of drones.

In Example 80, the subject matter of any one or more of Examples 78-79 optionally include wherein determining the velocity for each of the plurality of drones includes minimizing the velocity for each of the plurality of drones.

In Example 81, the subject matter of any one or more of Examples 67-80 optionally include saving a recovery time, flight path, and velocity for each of the plurality of drones in a recovery schedule.

In Example 82, the subject matter of Example 81 optionally includes transmitting the recovery schedule to each of the plurality of drones.

Example 83 is at least one computer-readable medium comprising instructions to perform any of the methods of Examples 67-82.

Example 84 is an apparatus comprising means for performing any of the methods of Examples 67-82.

Example 85 is a system for determining a recovery sequence for an aerial show, the system comprising: a processor; and a memory including instructions that, when executed by the processor; cause the processor to: receive frame data, the frame data defining a location for each of a plurality of drones forming an aerial image; receive recovery data for each of the plurality of drones, the recovery data defining a recovery point for each of the plurality of drones; and determine the recovery sequence for each of the plurality of drones using the recovery data and the frame data.

In Example 86, the subject matter of Example 85 optionally includes wherein the recovery data is received from each of the plurality of drones prior to a launch.

In Example 87, the subject matter of any one or more of Examples 85-86 optionally include, wherein the recovery point for each of the plurality of drones is a coordinate.

In Example 88, the subject matter of Example 87 optionally includes wherein the coordinate is a geographic coordinate.

In Example 89, the subject matter of any one or more of Examples 87-88 optionally include wherein the coordinate is relative to a fixed object.

In Example 90, the subject matter of any one or more of Examples 85-89 optionally include wherein determining the recovery sequence includes instructions that, when executed by the processor, cause the processor to determine an overall shortest flight distance for the plurality of drones.

In Example 91, the subject matter of any one or more of Examples 85-90 optionally include wherein determining the recovery sequence includes instructions that, when executed by the processor, cause the processor to determine a shortest flight distance for each of the plurality of drones.

In Example 92, the subject matter of any one or more of Examples 85-91 optionally include wherein determining the recovery sequence includes instructions that, when executed by the processor, cause the processor to determine a flight path for each of the plurality of drones from the location forming the aerial image to the recovery point.

In Example 93, the subject matter of Example 92 optionally includes wherein the flight path for a drone of the plurality of drones is a straight line.

In Example 94, the subject matter of any one or more of Examples 92-93 optionally include wherein the flight path for a drone of the plurality of drones a vertical segment having a present length above a launch pad.

In Example 95, the subject matter of any one or more of Examples 85-94 optionally include instructions that, when executed by the processor, cause the processor to save the recovery sequence to the memory.

In Example 96, the subject matter of any one or more of Examples 85-95 optionally include instructions that, when executed by the processor, cause the processor to determine a velocity for each of the plurality of drones.

In Example 97, the subject matter of Example 96 optionally includes wherein determining the velocity for each of the plurality of drones includes instructions that, when executed by the processor, cause the processor to minimize an average velocity for the plurality of drones.

In Example 98, the subject matter of any one or more of Examples 96-97 optionally include wherein determining the velocity for each of the plurality of drones includes instructions that, when executed by the processor, cause the processor to minimize the velocity for each of the plurality of drones.

In Example 99, the subject matter of any one or more of Examples 85-98 optionally include instructions that, when executed by the processor, cause the processor to save a recovery time, flight path, and velocity for each of the plurality of drones in a recovery schedule.

In Example 100, the subject matter of Example 99 optionally includes instructions that, when executed by the processor, cause the processor to transmit the recovery schedule to each of the plurality of drones.

Example 101 is a system for determining a recovery sequence for an aerial show, the system comprising: means for receiving frame data, the frame data defining a location for each of a plurality of drones forming an aerial image; means for receiving recovery data for each of the plurality of drones, the recovery data defining a recovery point for each of the plurality of drones; and means for determining the recovery sequence for each of the plurality of drones using the recovery data and the frame data.

In Example 102, the subject matter of Example 101 optionally includes wherein the location data is received from each of the plurality of drones.

In Example 103, the subject matter of any one or more of Examples 101-102 optionally include wherein the recovery point for each of the plurality of drones is a coordinate.

In Example 104, the subject matter of Example 103 optionally includes wherein the coordinate is a geographic coordinate.

In Example 105, the subject matter of any one or more of Examples 103-104 optionally include wherein the coordinate is relative to a fixed object.

In Example 106, the subject matter of any one or more of Examples 101-105 optionally include wherein the means for determining the recovery sequence includes means for determining an overall shortest flight distance for the plurality of drones.

In Example 107, the subject matter of any one or more of Examples 101-106 optionally include wherein the means for determining the recovery sequence includes means for determining a shortest flight distance for each of the plurality of drones.

In Example 108, the subject matter of any one or more of Examples 101-107 optionally include wherein the means for determining the recovery sequence includes means for determining a flight path for each of the plurality of drones from the location forming the aerial image to the recovery point.

In Example 109, the subject matter of Example 108 optionally includes wherein the flight path for a drone of the plurality of drones is a straight line.

In Example 110, the subject matter of any one or more of Examples 108-109 optionally include wherein the flight path for a drone of the plurality of drones a vertical segment having a present length above a launch pad.

In Example 111, the subject matter of any one or more of Examples 101-110 optionally include means for saving the recovery sequence to a memory of a computing device.

In Example 112, the subject matter of any one or more of Examples 101-111 optionally include means for determining a velocity for each of the plurality of drones.

In Example 113, the subject matter of Example 112 optionally includes wherein the means for determining the velocity for each of the plurality of drones includes means for minimizing an average velocity for the plurality of drones.

In Example 114, the subject matter of any one or more of Examples 112-113 optionally include wherein the means for determining the velocity for each of the plurality of drones includes means for minimizing the velocity for each of the plurality of drones.

In Example 115, the subject matter of any one or more of Examples 101-114 optionally include means for saving a recovery time, flight path, and velocity for each of the plurality of drones in a recovery schedule.

In Example 116, the subject matter of Example 115 optionally includes means for transmitting the recovery schedule to each of the plurality of drones.

Example 117 is at least one computer readable medium including instructions that, when executed by a processor, cause the processor to: receive frame data, the frame data defining a location for each of a plurality of drones forming an aerial image; receive recovery data for each of the plurality of drones, the recovery data defining a recovery point for each of the plurality of drones; and determine the recovery sequence for each of the plurality of drones using the recovery data and the frame data.

In Example 118, the subject matter of Example 117 optionally includes wherein the location data is received from each of the plurality of drones prior to a launch.

In Example 119, the subject matter of any one or more of Examples 117-118 optionally include wherein the recovery point for each of the plurality of drones is a coordinate.

In Example 120, the subject matter of Example 119 optionally includes wherein the coordinate is a geographic coordinate.

In Example 121, the subject matter of any one or more of Examples 119-120 optionally include wherein the coordinate is relative to a fixed object.

In Example 122, the subject matter of any one or more of Examples 117-121 optionally include wherein determining the recovery sequence includes instructions that, when executed by the processor, cause the processor to determine an overall shortest flight distance for the plurality of drones.

In Example 123, the subject matter of any one or more of Examples 117-122 optionally include wherein determining the recovery sequence includes instructions that, when executed by the processor, cause the processor to determine a shortest flight distance for each of the plurality of drones.

In Example 124, the subject matter of any one or more of Examples 117-123 optionally include wherein determining the recovery sequence includes instructions that, when executed by the processor, cause the processor to determine a flight path for each of the plurality of drones from the location forming the aerial image to the recovery point.

In Example 125, the subject matter of Example 124 optionally includes wherein the flight path for a drone of the plurality of drones is a straight line.

In Example 126, the subject matter of any one or more of Examples 124-125 optionally include wherein the flight path for a drone of the plurality of drones a vertical segment having a present length above a launch pad.

In Example 127, the subject matter of any one or more of Examples 117-126 optionally include instructions that, when executed by the processor, cause the processor to save the recovery sequence to a memory of a computing device.

In Example 128, the subject matter of any one or more of Examples 117-127 optionally include instructions that, when executed by the processor, cause the processor to determine a velocity for each of the plurality of drones.

In Example 129, the subject matter of Example 128 optionally includes wherein determining the velocity for each of the plurality of drones includes instructions that, when executed by the processor, cause the processor to minimize an average velocity for the plurality of drones.

In Example 130, the subject matter of any one or more of Examples 128-129 optionally include wherein determining the velocity for each of the plurality of drones includes instructions that, when executed by the processor, cause the processor to minimize the velocity for each of the plurality of drones.

In Example 131, the subject matter of any one or more of Examples 117-130 optionally include instructions that, when executed by the processor, cause the processor to save a recovery time, flight path, and velocity for each of the plurality of drones in a recover schedule.

In Example 132, the subject matter of Example 131 optionally includes instructions that, when executed by the processor, cause the processor to transmit the recovery schedule to each of the plurality of drones.

Example 133 is a drone comprising: a flight mechanism; a processor in electrical communication with the flight mechanism; and a memory storing instructions that, when executed by the processor, cause the processor to: receive a launch sequence or a recovery sequence from a remote computer, and transmit an activation signal to the flight mechanism, the activation signal transmitted in accordance with the launch sequence or the recovery sequence.

In Example 134, the subject matter of Example 133 optionally includes wherein the launch sequence defines a launch time and a launch velocity.

In Example 135, the subject matter of any one or more of Examples 133-134 optionally include wherein the recovery sequence defines a recovery time and a recovery velocity.

In Example 136, the subject matter of any one or more of Examples 133-135 optionally include a position sensor, wherein the instructions, when executed by the processor, further cause the processor to: receive position data from the position sensor, the position data defining a location of the drone; and transmit the location of the drone to the remote computer.

In Example 137, the subject matter of Example 136 optionally includes wherein the location of the drone is a launch location.

In Example 138, the subject matter of any one or more of Examples 133-137 optionally include a position sensor; wherein the instructions, when executed by the processor, further cause the processor to: determine a velocity of the drone during flight; transmit a first signal to the flight mechanism to increase power to the flight mechanism when the velocity of the drone during flight is less than a preset velocity defined by the launch sequence or the recovery sequence; and transmit a second signal to the flight mechanism to decrease power to the flight mechanism when the velocity of the drone during flight is greater than the preset velocity defined by the launch sequence or the recovery sequence.

Example 139 is a method for launching or recovering a drone, the method comprising: receiving, at the drone from a remote computer, a launch sequence or a recovery sequence; and transmitting an activation signal to a flight mechanism, the activation signal transmitted in accordance with the launch sequence or the recovery sequence.

In Example 140, the subject matter of Example 139 optionally includes wherein the launch sequence defines a launch time and a launch velocity.

In Example 141, the subject matter of any one or more of Examples 139-140 optionally include wherein the recovery sequence defines a recovery time and a recovery velocity.

In Example 142, the subject matter of any one or more of Examples 139-141 optionally include determining a velocity of the drone during flight; increasing power to the flight mechanism when the velocity of the drone during flight is less than a preset velocity defined by the launch sequence or the recovery sequence; and decreasing power to the flight mechanism when the velocity of the drone during flight is greater than the preset velocity defined by the launch sequence or the recovery sequence.

In Example 143, the subject matter of any one or more of Examples 139-142 optionally include receiving position data from a position sensor; determining a location of the drone; and transmitting a location of the drone to the remote computer.

In Example 144, the subject matter of Example 143 optionally includes wherein the location of the drone is a launch location.

Example 145 is at least one computer-readable medium comprising instructions to perform any of the methods of Examples 139-144.

Example 146 is an apparatus comprising means for performing any of the methods of Examples 139-144.

Example 147 is a drone comprising: means for receiving, at the drone from a remote computer, a launch sequence or a recovery sequence; and means for transmitting an activation signal to a flight mechanism, the activation signal transmitted in accordance with the launch sequence or the recovery sequence.

In Example 148, the subject matter of Example 147 optionally includes wherein the launch sequence defines a launch time and a launch velocity.

In Example 149, the subject matter of any one or more of Examples 147-148 optionally include wherein the recovery sequence defines a recovery time and a recovery velocity.

In Example 150, the subject matter of any one or more of Examples 147-149 optionally include means for determining a velocity of the drone during flight; means for increasing power to the flight mechanism when the velocity of the drone during flight is less than a preset velocity defined by the launch sequence or the recovery sequence; and means for decreasing power to the flight mechanism when the velocity of the drone during flight is greater than the preset velocity defined by the launch sequence or the recovery sequence.

In Example 151, the subject matter of any one or more of Examples 147-150 optionally include means for receiving position data from a position sensor; means for determining a location of the drone; and means for transmitting a location of the drone to the remote computer.

In Example 152, the subject matter of Example 151 optionally includes wherein the location of the drone is a launch location.

Example 153 is at least one computer readable medium including instructions that, when executed by a processor, cause the processor to: receive, from a remote computer, a launch sequence or a recovery sequence from a remote computer, and transmit, to a flight mechanism in electrical communication with the processor, an activation signal, the activation signal transmitted in accordance with the launch sequence or the recovery sequence.

In Example 154, the subject matter of Example 153 optionally includes wherein the launch sequence defines a launch time and a launch velocity.

In Example 155, the subject matter of any one or more of Examples 153-154 optionally include wherein the recovery sequence defines a recovery time and a recovery velocity.

In Example 156, the subject matter of any one or more of Examples 153-155 optionally include wherein the instructions, when executed by the processor, farther cause the processor to: receive, from a position sensor in electrical communication with the processor, position data, the position data defining a location of the drone; and transmit the location of the drone to the remote computer.

In Example 157, the subject matter of Example 156 optionally includes wherein the location of the drone is a launch location.

In Example 158, the subject matter of any one or more of Examples 153-157 optionally include wherein the instructions, when executed by the processor, thither cause the processor to: determine a velocity of the drone during flight; transmit a first signal to the flight mechanism to increase power to the flight mechanism when the velocity of the drone during flight is less than a preset velocity defined by the launch sequence or the recovery sequence; and transmit a second signal to the flight mechanism to decrease power to the flight mechanism when the velocity of the drone during flight is greater than the preset velocity defined by the launch sequence or the recovery sequence.

Example 159 is at least one machine-readable medium including instructions that, when executed by processing circuitry, cause the processing circuitry to perform operations to implement of any of Examples 1-158.

Example 160 is an apparatus comprising means to implement of any of Examples 1-158.

Example 161 is a system to implement of any of Examples 1-158.

Example 162 is a method to implement of any of Examples 1-158.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for determining a launch sequence for an aerial show, the method comprising:
receiving, at a computing device comprising a processor, location data for each of a plurality of drones, the location data defining a launch point for each of the plurality of drones;
receiving, at the computing device, frame data, the frame data defining a location for each of the plurality of drones to form an aerial image; and
determining, by the computing device, the launch sequence for each of the plurality of drones using the location data and the frame data.

2. The method of claim 1, wherein the location data is received from each of the plurality of drones.

3. The method of claim 1, wherein the launch point for each of the plurality of drones is a coordinate.

4. The method of claim 1, wherein determining the launch sequence includes determining an overall shortest flight distance for the plurality of drones.

5. The method of claim 1, wherein determining the launch sequence includes determining a flight path for each of the plurality of drones from the launch point to the location within the aerial image for each of the plurality of drones.

6. The method of claim 1, further comprising determining a velocity for each of the plurality of drones.

7. The method of claim 1, further comprising saving a launch time, flight path, and velocity for each of the plurality of drones in a launch schedule.

8. The method of claim 1, further comprising transmitting the launch sequence to each of the plurality of drones.

9. A system for determining a launch sequence for an aerial show, the system comprising:
a processor; and
a memory including instructions that, when executed by the processor, cause the processor to:
receive location data for each of a plurality of drones, the location data defining a launch point for each of the plurality of drones,
receive frame data defining a location for each of the plurality of drones to form an aerial image, and
determine the launch sequence for each of the plurality of drones using the location data and the frame data.

10. The system of claim 9, wherein determining the launch sequence includes instructions that, when executed by the processor, cause the processor to determine an overall shortest flight distance for the plurality of drones.

11. The system of claim 9, wherein determining the launch sequence includes instructions that, when executed by the processor, cause the processor to determine a flight path for each of the plurality of drones from the launch point to the location within the aerial image for each of the plurality of drones.

12. The system of claim 9, further comprising instructions that, when executed by the processor, cause the processor to determine a velocity for each of the plurality of drones.

13. The system of claim 9, further comprising instructions that, when executed by the processor, cause the processor to:
save a launch time, flight path, and velocity for each of the plurality of drones in a launch schedule; and
transmit the launch sequence to each of the plurality of drones.

14. A method for determining a recovery sequence, the method comprising:
receiving, at a computing device comprising a processor, frame data, the frame data defining a location for each of a plurality of drones forming an aerial image;
receiving, at the computing device, recovery data for each of the plurality of drones, the recovery data defining a recovery point for each of the plurality of drones; and
determining, by the computing device, the recovery sequence for each of the plurality of drones using the recovery data and the frame data.

15. The method of claim 14, wherein determining the recovery sequence includes determining an overall shortest flight distance for the plurality of drones.

16. The method of claim 14, wherein determining the recovery sequence includes determining a flight path for each of the plurality of drones from the location forming the aerial image to the recovery point.

17. The method of claim 14, further comprising determining a velocity for each of the plurality of drones.

18. The method of claim 17, wherein determining the velocity for each of the plurality of drones includes minimizing an average velocity for the plurality of drones.

19. The method of claim 14, further comprising saving a recovery time, flight path, and velocity for each of the plurality of drones in a recovery schedule.

20. The method of claim 19, further comprising transmitting the recovery schedule to each of the plurality of drones.

21. A drone comprising:
a flight mechanism;
a processor in electrical communication with the flight mechanism; and
a memory storing instructions that, when executed by the processor, cause the processor to:
receive a launch sequence or a recovery sequence from a remote computer, and
transmit an activation signal to the flight mechanism, the activation signal transmitted in accordance with the launch sequence or the recovery sequence.

22. The drone of claim 21, wherein the launch sequence defines a launch time and a launch velocity.

23. The drone of claim 21, wherein the recovery sequence defines a recovery time and a recovery velocity.

24. The drone of claim 21, further comprising a position sensor, wherein the instructions, when executed by the processor, further cause the processor to:
receive position data from the position sensor, the position data defining a location of the drone; and
transmit the location of the drone to the remote computer.

25. The drone of claim 21, further comprising a position sensor, wherein the instructions, when executed by the processor, further cause the processor to:
determine a velocity of the drone during flight;
transmit a first signal to the flight mechanism to increase power to the flight mechanism when the velocity of the drone during flight is less than a preset velocity defined by the launch sequence or the recovery sequence; and
transmit a second signal to the flight mechanism to decrease power to the flight mechanism when the velocity of the drone during flight is greater than the preset velocity defined by the launch sequence or the recovery sequence.
